(19) United States
(12) Patent Application Publication
(10) Pub. No.: US 2013/0265939 A1
(43) Pub. Date: Oct. 10, 2013

(54) Network Element and Method of Communication in a Wireless Communication Network

(71) Applicants: Klaus Ingemann Pedersen, Aalborg (DK); Agnieszka Szufarska, Gdansk (PL); Karol Drazynski, Wroclaw (PL)

(72) Inventors: Klaus Ingemann Pedersen, Aalborg (DK); Agnieszka Szufarska, Gdansk (PL); Karol Drazynski, Wroclaw (PL)

(73) Assignee: Nokia Siemens Networks Oy, Espoo (FI)

(21) Appl. No.: 13/822,028

(22) PCT Filed: Sep. 10, 2010
(86) PCT No.: PCT/EP2010/063298

§ 371 Date: Jun. 3, 2013

(51) Int. Cl. H04W 24/02

(52) U.S. Cl. CPC H04W 24/02
USPC 370/328

(57) ABSTRACT

A network element for a communication network, wherein the network element includes an input interface adapted to receive a measurement report associated with a further network element, wherein the measurement report includes an identifier value identifying the further network element and a first value of a characteristic feature, and a comparing unit adapted to compare the first value with a second value of the same characteristic feature stored for said identifier value in the network element. Furthermore, the network element includes a signal generating unit adapted to generate a signal in case the comparison of the first value and the second value indicates that an appropriately defined distance between the first value and the second value is above a predetermined threshold.

### FIELD OF INVENTION

The present invention relates to the field of network elements, in particular to base stations and user equipments in a mobile or wireless communication network. Furthermore, the invention relates to a mobile or wireless communication network, a method of communication in a communication network, a program element, and a computer-readable medium.

### ART BACKGROUND

In today's communication networks, in particular in mobile or wireless communication networks, the performance of the communication network is of great interest. One possible feature to increase the performance, e.g. the transmission or sending resources, of the communication may be the use of so-called local area nodes in order to unburden the serving macro base stations of the communication network. These local nodes may form a dense network of so-called femto cells each of which is served by one local or home evolved NodeBs (HeNBs). The local area (LA) nodes may be configured with open, closed or hybrid access. The communication between the LA nodes has the aim of enabling of efficient allocation of frequency resources to the nodes. The general communication scheme is described in the concept of autonomous component carrier selection (ACCS).

The ACCS for heterogeneous environments, as described in R1-09 4659, uses a background interference matrix (BIM) for selection of secondary component carriers, as described in R1-090235. For this purpose each cell maintains information on all the potential interfering cells and a corresponding conditional cell interference (C/I) value. The measurements are gathered in a way that for each active UE connected to the cell, reference signal received power (RSRP) measurements are reported. These measurements are conducted both towards the serving (macro and/or femto) cell and the surrounding cells. Eventually based on those measurements the background interference matrix is formed.

However, due to the high density of such femto nodes or LA nodes it may come to some interference effects in the communication between the different LA nodes. In particular, in a communication between the different LA nodes being present in one macro cell served by a common macro base station.

Thus, there may be a need for a network element and a method of communication in a communication network which may enable the provision of an efficient management between a macro cell and a femto cell or between two femto cells.

### SUMMARY OF THE INVENTION

This need may be met by a network element, a mobile communication network, a method of communication in a communication network, a program element, and a computer-readable medium according to the independent claims. Further embodiments of the present invention are described by the dependent claims. According to an exemplary aspect a network element for a communication network comprising a plurality of network elements is provided, wherein the network element comprises an input interface adapted to receive a measurement report associated with a further network element, wherein the measurement report comprises an identifier value identifying the further network element and a first value of a characteristic feature associated with the further network element, and a comparing unit adapted to compare the first value with a second value of the same characteristic feature stored for said identifier value in the network element. Furthermore, the network element comprises a signal generating unit adapted to generate a signal in case the comparison of the first value and the second value indicates that the distance or difference between the first value and the second value is above a predetermined threshold.

In particular, the network element may be a so-called femto base station, e.g. a home eNB or a base station of a cordless home phone. However, it may also be a user equipment (UE), e.g. a mobile phone, a laptop computer, a PDA or the like, or any other suitable element adapted to communicate in a communication network. The communication network may be a mobile or wireless communication network, like a UMTS or 3GPP LTE network. It should be mentioned that the term “stored” may denote any volatile or non-volatile storing in a storage unit and/or memory unit. For example also a latch or a flip-flop may be used for such a storing.

In particular, the measurement report may be transmitted or reported by the further network element(s) itself or by a third network element to the network element. That is, a third network element may function as a kind of relay network element or relay node which relays the measurement report of the further network element to the network element or which just includes information or data about the further network element in its own measurement report since the further network element is one of its neighbouring network elements.

The network element may be adapted to select the at least one further network element for performing a measurement and sending a measurement report to the network element. In addition the network element may be adapted to configure the kind or content of the measurement report and it may be adapted to configure when the at least one further network element shall send which kind of measurement report.

In particular, the network element may be adapted to select at least one third network element for performing measurements on signals received from the at least one further network element and sending of measurement reports comprising the measurement results obtained for the at least one further network element to the network element. In addition the network element may be adapted to configure the kind or content of the measurement report and an identity of the at least one further network element and when the at least one third network element shall send which kind of measurement report for which of the further network elements.

According to an exemplary aspect a communication network is provided comprising a plurality of network elements according to the exemplary aspect.

According to an exemplary aspect a method of communication by a network element in a communication network is provided, wherein the method comprises receiving a measurement report associated with a further network element, wherein the measurement report comprises an identifier value identifying the further network element and a first value of a characteristic feature associated with the further network element, and comparing the first value with a second value of the same characteristic feature stored for said identifier value in the network element. Furthermore, the method comprises generating a signal in case the comparison of the first value and the second value results indicates that the distance or difference between the first value and the second value is above a predetermined threshold.

In particular, the signal may indicate a confusion or a confusion problem in the communication network or may at least indicate a likely confusion problem. In this application the term “confusion” or “confusion problem” may particularly denote the fact that an identifier which is intended to identify an entity, e.g. a network element, like a home eNB or base station, may not be unique in a communication network or a part of the same. This lack of uniqueness will lead to a confusion which physical network element, local area or femto cell is associated with the respective identifier.

According to an exemplary aspect a program element is provided, which, when being executed by a processor, is adapted to control or carry out a method according to an exemplary aspect.

According to an exemplary aspect a computer-readable medium is provided, in which a computer program is stored which, when being executed by a processor, is adapted to control or carry out a method according to an exemplary aspect.

By providing a network element and a corresponding method of operating the same according to an exemplary aspect it may be possible to analyze whether a so-called confusion or confusion state may be present or likely in a communication network. In particular, the signal generated may be a signal indicating that a confusion is likely and that the situation or the state of the communication network has to be analyzed further. Thus, when providing a suitable threshold for values of a characterising feature it may be possible to determine a likely confusion while at the same time the communication is not hindered or slowed down due to wrongly scheduled or performed communication messages.

A gist of an exemplary aspect may be seen in providing a network element and a method of operating the network element in such a way to identify a likely confusion problem in a communication network. The method may be based on a comparison between different measurements reports received by a network element, e.g. a local area node. In case the comparison results in a difference value above a predetermined threshold a signal is generated indicating a likely confusion problem.

Next, further exemplary embodiments of the network element are described. However, these embodiments also apply to the mobile communication network, the method of communication in a communication network, the program element, and the computer-readable medium.

According to another exemplary embodiment the network element further comprises a sending unit adapted to send the generated signal to another network element.

In particular, the another network element may be the further network element. However, the generated signal may be sent to more than one network element. For example, the generated signal may be sent to one or all network elements of a communication network which have sent a measurement report including measurements, information or data associated with the identifier value which may be determined to be possibly affected by a confusion. Moreover, the sending unit may comprise an antenna or may be formed by an antenna. Additionally, the receiving unit may comprise an antenna as well.

According to another exemplary embodiment of the network element the sending unit is further adapted to send a measurement report.

In particular, the network element may be adapted to send and receive a measurement report. For example, the network element and the further network element may be similar or identically formed. That is, one and the same network element may function or may be operated as the network element or the further network element according to the circumstances.

According to another exemplary embodiment the network element further comprises a determining unit adapted to determine a background interference matrix based on received measurement reports.

In particular, the network element may further comprise a storage unit adapted to store information or data, e.g. received measurement reports and/or background interference matrixes. For this purpose each cell or the respective network element forming the cell, e.g. a HeNB stores or maintains information on all the potential interfering cells or network elements and a corresponding conditional channel interference value. Moreover, the network element may comprise a processing unit or processor which may be used or may be adapted to implement the determining unit and/or the comparing unit and/or the signal generating unit. Thus, all or some of the listed units may be implemented in software. Alternatively, the units may be implemented or formed by hardware, e.g. dedicated integrated circuits or may be implemented in a hybrid form.

Next, further exemplary embodiments of the method of communication are described. However, these embodiments also apply to the communication network, the network element, the program element, and the computer-readable medium.

According to another exemplary embodiment of the method the identifier value is the value of the physical cell identity. That is, the physical cell identity (PCI) of the further network element, e.g. another HeNB or local area node or access node, may be part or may form the identifier which is part of the measurement report received by the network element. Thus, the further network element may transmit its PCI value as part of the measurement report or a third network element may transmit the PCI of at least one further network element as part of the measurement report.

According to another exemplary embodiment the method further comprises sending the generated signal. In particular, the generated signal may be sent to the further network element.

According to another exemplary embodiment of the method the generated signal is a request signal.

In particular, the request signal may request the further network element to send a further identifier value. In particular, the further identifier value may be associated with another identifier parameter. For example in case the identifier value may be related to the PCI of the further network element, the further identifier value may be associated to the cell global identifier. In some embodiments the request signal may be sent to more than one network element. In particular, the generated signal may be sent to all third network elements of a communication network which have sent a measurement report including measurements, information or data, e.g. values of characterizing features, associated with the identifier value of a further network element which has been determined to be possibly affected by a confusion.

According to another exemplary embodiment the method further comprises receiving a further identifier value identifying the further network element.

In particular, the further identifier value may be a unique identifier, e.g. may relate to the cell global identity (CGI) parameter or to any other suitable identifier which uniquely identifies the further network element. Thus, a truly unique identifier may be sent by the further network element, e.g. upon receiving of a request signal. By receiving the CGI value a potential confusion may be resolved.

According to another exemplary embodiment of the method the characteristic feature is a channel interference and/or identifier values of at least one neighbouring network element.

That is, the characteristic feature may indicate one or more channel interference values which were measured, determined, calculated or estimated by the further network element or a third network element and which may be sent from the further network element or a third network element to the network element. The channel interference value may be a suitable value or the channel interference may be a suitable parameter or characteristic to detect or determine a possible confusion, since in case two distinct channel interference values are received associated with the same identifier value, e.g. PCI value, it may be likely that the same PCI value is used for two distinct network elements, i.e. a confusion is likely. A suitable predetermined threshold in this case may be 3 dB, 5 dB, 10 dB or 15 dB. That is, in case the difference between channel interference values received in connection with the same identifier value is above the predetermined threshold of 5 dB for example it is assumed, that the same identifier is used by two distinct network elements.

Another suitable parameter or characteristic feature which may be included in the measurement report may be the reported neighbours of the further network element. In case different neighbours are reported for the same PCI value in different message reports it may also be likely that the same PCI is used by more than one network element. Thus, also the reported neighbours may be a suitable parameter for determining or detecting a confusion. This reporting or determining of the neighbourhood may be performed in two ways.

For example, in a first measurement report RSRP values for PCIs 1, 2 and 3 are listed, while in a second measurement report RSRP values for PCIs 1, 4 and 5 are listed. These measurement reports may be transmitted to the network element by different network elements, e.g. HeNBs or UEs, by the same network elements, and in particular by other network element(s) than the further network element.

The measurement reports may lead to the fact that different neighbourhoods for PCI=1 may be determined, namely including PCIs 2, 3 and including PCIs 4, 5, respectively, indicating that the network elements identified by or associated with PCI=1 may be different for the two measurement reports. In this case the network element may send the generated signal to one or all of the network elements which reported respective measurement reports. This, in case the generated signal comprises or forms a request signal for an additional identifier for all network elements identified by the same PCI a unique identifier, e.g. the CGI value, may be received. This, embodiment may be in particular suitable in cases in which the measurement reports are transmitted or reported by third network elements, i.e. not the network element and not the further network element. In this respect, the network element may be adapted to determine the neighbourhood of the third network elements based on the measurement reports and may infer from this information the neighbourhood relationship between the at least one further network element and the network element. In particular the network element may determine if a certain PCI in the received measurement reports is unique in its neighbourhood.

In a second way the further network element itself may report its neighbourhood to the network element directly. For example one network element having allocated a PCI value of 1 may transmit a “neighbourhood” of network elements having corresponding PCI values 2, 3 and 4 while another network element having allocated a PCI value of 1 as well may transmit a “neighbourhood” of network elements having corresponding PCI values 5, 6 and 7. Also these two measurement reports may indicate that the two network elements having allocated thereto the same PCI value of 1 are different from each other. This, embodiment of determining or reporting neighbourhoods may be in particular suitable in cases in which the measurement reports are transmitted or reported by the further network element itself.

According to another exemplary embodiment the method further comprises determining a background interference matrix based on received measurement reports.

In particular, the background interference matrix may be updated, calculated or estimated. In particular, the background interference matrix (BIM) may include data or functions derived from the channel interference values. Additionally, the BIM may also include the PCI values and/or the CGI values included in the received measurement reports or may include data or functions derived from the PCI values and/or CGI values. That is, the BIM may include data which are indicative for the channel interference, the PCI values and/or the CGI values. The BIM may be determined by the network element and/or by the further network element.

According to another exemplary embodiment the method further comprises receiving a further measurement report which comprises the second value. That is, the second value may be transmitted to the network element by a further measurement report which may be transmitted in advance to the measurement report comprising the first value. After receiving of the further measurement report the second value may be stored so that it can be afterwards compared to the first value. In particular, the further or second measurement report may be reported or transmitted to the network element by another network element than the (first) measurement report comprising the first value. Thus, the first measurement report may be transmitted by a network element NE_1 while the second measurement may be transmitted by another network element NE_2 to the network element. According to exemplary embodiments, the generated signal may then be sent to one, several or all concerned network elements, i.e. network elements which transmitted a measurement report including a specific identifier which was determined to be possibly affected by a confusion. For example, in case the generated signal is a request signal, all concerned network elements may be requested to transmit a further or additional identifier which may be truly unique, e.g. the cell global identifier.

The first and the second value obtained from the first and the second measurement report may not only comprise the channel interference values obtained in the first and the second measurement report for a certain identifier Id0 but the first value may comprise the whole set of interference values and the associated identifiers obtained in the first measurement report and the second value may comprise the whole set of interference values and the associated identifiers obtained in the second measurement report.

The comparing of the first value and the second value involves an appropriately selected metric for measuring the distance between the first and the second value.

In an embodiment the distance d(Id0, r1, r2) between two measurement reports r1 and r2 for an identifier Id0 may be determined by calculating the absolute value of the difference between the interference value obtained for the identifier Id0 in the first measurement report r1 and the interference value obtained for the identifier Id0 in the second measurement report r2.

In an embodiment the distance d(Id0, r1, r2) between two measurement reports r1 and r2 for an identifier Id0 may be determined by counting the identifiers which are contained in only one of the measurement reports but not in the other measurement report when both measurement reports contain the identifier Id0.

In an embodiment the distance d(Id0, r1, r2) between two measurement reports r1 and r2 for an identifier Id0 may be determined as an inner product <dIf, dIf> of the difference vector dIf=If1−If2 between the vector of interference values If1 contained in r1 and the vector of interference values If2 contained in r2 when both measurement reports r1 and r2 contain the identifier Id0. The vectors If1 and If2 are arranged such that interference values for the same identity value are assigned to the same index in If1 and If2. If a certain identity value is contained in only one of the reports r1 or r2 the respective interference value for the other report is set to 0 in the vector of interference values associated with the other report.

The network element may store several second measurement reports associated with an identity Id0 of a further network element. These measurement reports are considered to be typical for different groups of measurement reports containing identity Id0. These typical second measurement reports may be obtained by some kind of averaging in a certain time window over the received measurement reports containing an interference value for Id0. Several typical second measurement reports may be obtained for an identity Id0 when the received measurement reports for Id0 form clusters, i.e. groups of measurement reports wherein the distance between measurement reports of the same group is small compared to the distance between any measurement report of the group and any measurement report of another group.

A first reason for the formation of more than one cluster of measurement reports for an identity value may be that the identity value is not unique and different clusters of measurement reports are associated with different further network elements featuring the same identity value.

Another reason for the formation of more than one cluster of measurement reports for an identity value may be the presence of significant shadowers or reflectors. For instance there may be two typical second measurement reports, i.e. two clusters or groups, for the identity value Id0. One of these typical second measurement reports comprises interference values for identity values Id0, Id1 and Id2 while the other typical second measurement report comprises interference values for identity values Id0, Id3 and Id4. But the sending of the generated signal to the further network elements featuring identity Id0 as a request to transmit a unique identifier has shown that the interference values for Id0 in the measurement reports of both clusters refer to the same further network element featuring identity Id0. This observation may be interpreted consistently by assuming the presence of a shadower which is hiding network elements featuring Id3 and Id4 from at least one of the further or third network elements reporting interference values associated with identity values Id0, Id1 and Id2, and which is further hiding network elements featuring Id1 and Id2 from at least one of the further or third network elements reporting interference values associated with identity values Id0, Id3 and Id4.

In an embodiment the network node may be adapted to employ a method for checking if a new first measurement report containing an interference value associated with an identity value Id0 is consistent for Id0 with the previously received measurement reports containing Id0. The first measurement report may be considered consistent for Id0 if the distance d(Id0, r1, r2) between the new first measurement report r1 and one of the typical second measurement reports for Id0 does not exceed a predetermined threshold. An inconsistent measurement report r1 may indicate a confusion problem for Id0 and the network element may request the transmission of a unique identifier from the further network element associated with Id0 in the measurement report r1.

The measurement reports may contain information about the positions of the network elements sending a measurement report relative to the network element receiving a measurement report, and information about the positions of the network elements characterized or reported in a measurement report relative to the network element sending the measurement report. Moreover, the measurement reports may contain information about the positions of reflectors and shadowers relative to the network element and relative to the further or third network elements. This information may be derivable from the sets of identity values and the associated interference values in the received measurement reports.

In an embodiment the network element may be adapted to employ a method for deriving this positioning information from the measurement reports and may combine it with any other positioning information available in the network element and may infer from this information an estimate of a map of its neighbourhood which may comprise the positions of the network elements, the positions of shadowers, the path loss caused by the shadowers, the positions of reflectors and/or the attenuations caused by the reflectors. The network element may further be adapted to employ a method for checking if a received first measurement report r1 is consistent with the previously received measurement reports for an identity Id0 by determining the position of the network element featuring Id0 based on the received first measurement report r1 in the estimated map. The received first measurement report r1 may be considered to be consistent with the estimated map for identity Id0 if the distance between the determined position of the network element featuring Id0 and the position of a network element featuring Id0 in the estimated map does not exceed a predetermined threshold. An inconsistent measurement report r1 may indicate a confusion problem for Id0 and the network element may request the transmission of a unique identifier from the further network element associated with Id0 in the measurement report r1.

Summarizing an exemplary aspect may be seen in the fact that a method of communication in a communication network, e.g. a wireless communication network according to the so-called autonomous component carrier selection (ACCS) concept, may be provided, in which background interference matrix (BIM) for selection of secondary component carriers are used. For this purpose each cell or HeNB may maintain or store information on all the potential interfering cells and a corresponding conditional channel interference (C/I) value. The measurements may be gathered in a way that for each active UE connected to the cell, reference signal received power (RSRP) measurements are reported. These measurements may then be conducted both towards the serving cell and the surrounding cells. Eventually based on those measurements the background interference matrix may be formed.

However, since ACCS has been designed for heterogeneous networks, where multiple un-coordinated HeNBs can be deployed parallel to evolved NodeB (eNBs) it is very likely that the PCI confusion problem (as described in R2-100960 where multiple HeNBs within the coverage of a source eNB have the same PCI values assigned) will influence the BMI matrix causing confusion since different measurements might be reported for the same PCI value. This may cause the BIM mechanism to fail since it is undefined what will happen if multiple measurements with same PCI value but different RSRP values are received. This confusion problem may be solved by a network element and a communication method according to an exemplary aspect by determining whether for a same identifier value, e.g. a PCI value, it is likely that the value is used more than once. According to an exemplary aspect this determining step is based on a comparison whether for the same PCI value different values of characteristic features, e.g. channel interference value or different groups or sets of neighbours are reported in an RSRP message. In case the channel interference values differ from each other for more than a predetermined threshold it is likely that the respective identifier is used by more than one network element, e.g. a HeNB, a local area node or a user equipment. Thus, a confusion problem may be determined. In order to solve the respective confusion problem a network element, e.g. the one determining the likely confusion problem may optionally requests for a further identifier, e.g. the so-called cell global identifier (CGI) or any other suitable unique identifier. This, further identifier may then be incorporated in the BIM matrix of the network element. In particular, the method may be used to resolves the ambiguity in the BIM matrixes which may be caused by dense deployments of LA nodes and may be used for the operation of eNBs or HeNBs.

Thus, the network element and the communication method according to the exemplary aspect may provide a solution for PCI confusion resolution and thus may provide for an efficient communication or operation method when deploying rather dense deployments of local area (LA) nodes. It should be noted that the method may be performed when a new femto cell base station enters a new macro cell or is newly switched on. Additionally, the method may be performed periodically in order to update the BMI of each network element or each cell.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered to be disclosed within this application.

The aspects and exemplary embodiments defined above and further aspects of the invention are apparent from the example of embodiment to be described hereinafter and are explained with reference to these examples of embodiment.

### BRIEF DESCRIPTION OF THE DRAWINGS

FIG. 1 schematically shows a communication network.

FIG. 2 schematically shows exemplary background interference matrixes.

FIG. 3 schematically shows a physical cell identity confusion.

### DETAILED DESCRIPTION

The illustration in the drawings is schematic. It is noted that in different figures, similar or identical elements are provided with similar or identical reference signs.

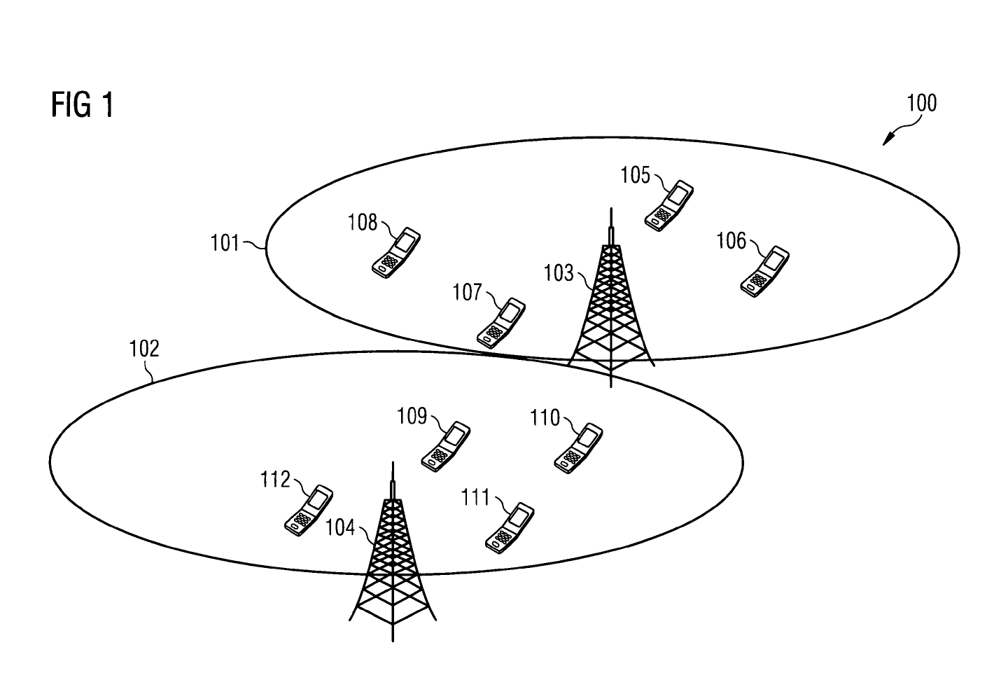

With reference to FIG. 1 a communication network 100 will be described. The communication network may be a cellular mobile communication network.

The communication network 100 comprises two cells 101 and 102 each comprising a corresponding macro base station 103 and 104, respectively. Furthermore, a plurality of network elements 105, 106, 107, 108, 109, 110, 111, 112, and 113 are schematically depicted in FIG. 1. However, the communication network may of course comprise a much higher number of macro base stations and network elements, which may be formed by base stations of cordless telephones, HeNBs, mobile phones, computers, PDA, or the like, i.e. every communication system which is suitable for a wireless communication. Each of the plurality of network elements may define a single femto cell, i.e. may function as a femto base station as well. Some or all macro base stations 103 and 104 of the communication network may be suitable as femto/macro base station management systems. Alternatively, special network elements may be provided as the femto/macro base station management systems.

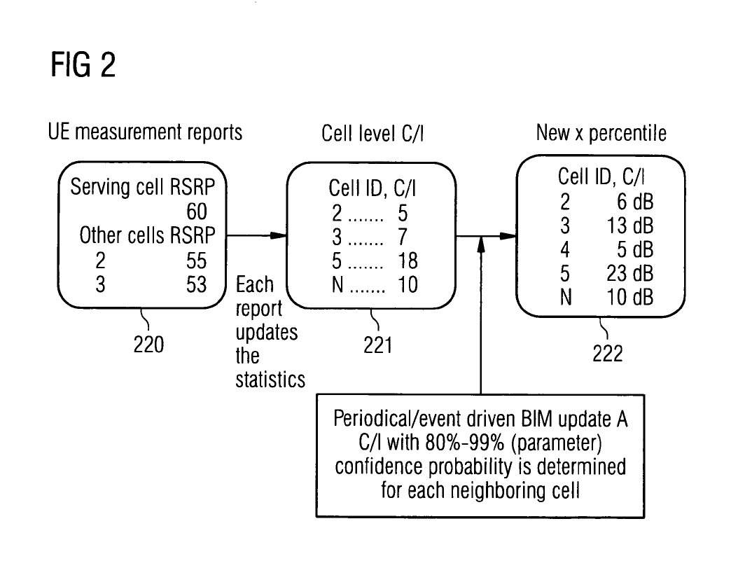

FIG. 2 schematically shows exemplary background interference matrixes. In particular, FIG. 2 shows some parameter and corresponding values of a measurement report 220 sent by a user equipment to NBs of the communication network. For illustrative purposes some values are indicated in the table symbolizing the measurement report. In particular, the reference signal received power (RSPS) for the serving cell is indicated to be 60, while for a cells number 2 and number 3 the corresponding RSRP values are 55 and 53, respectively.

Each message report, whether sent during a periodically update or event driven updates the statistics and may be used to calculate or determine channel interference (C/I) values and may be used to update background interference matrixes (BIM). The respective calculated cell level C/I values 221 may be 5 dB for cell having ID number 2, 7 dB for cell having ID number 3, 18 dB for cell having ID number 5, and 10 dB for cell having ID number N. From these C/I values an updated BIM 222 may be formed. In particular, the updated BIM may be determined in such a way that a C/I value with 80% to 99% confidence probability is determined for each neighboring cell. As some examples the new BIM may comprise a C/I value of 6 dB may be calculated for cell ID number 2, a C/I value of 13 dB may be calculated for cell ID number 3, a C/I value of 5 dB may be calculated for cell ID number 4, a C/I value of 23 dB may be calculated for cell ID number 5, and a C/I value of 10 dB may be calculated for cell ID number N.

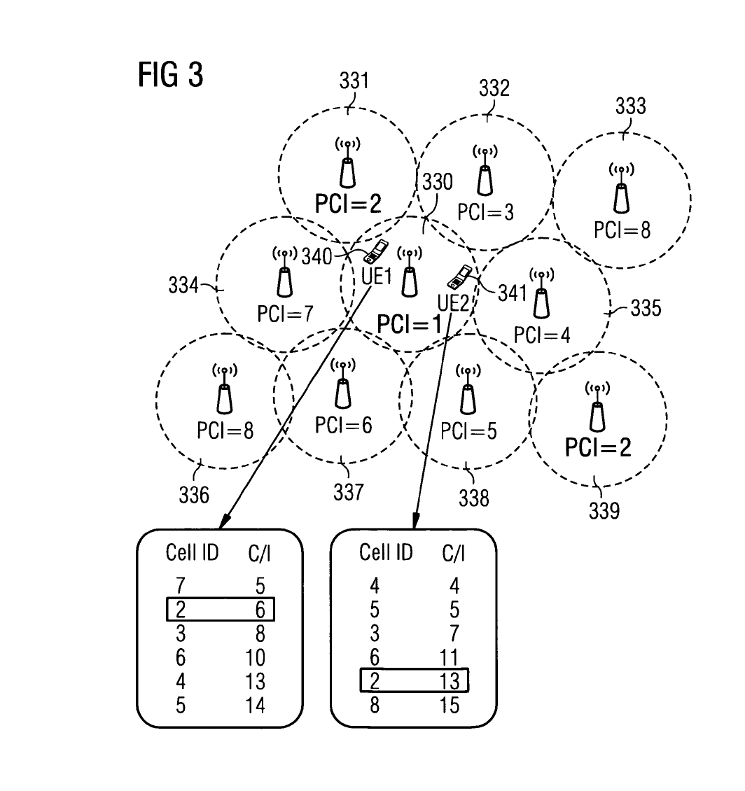

FIG. 3 schematically shows a physical cell identity (PCI) confusion. In particular, FIG. 3 shows schematically ten femto cells or local area nodes 330, 331, 332, 333, 334, 335, 336, 337, 338, and 339 and there respective PCI values. However, since the PCI values are randomly selected it may happen that some local area (LA) nodes select the same PCI values. This is schematically shown in FIG. 3 in that LA node 331 and 339 have both selected 2 as their PCI value. In case cell 330 creates its BIM it receives reports on different cells with PCI=2, wherein the reports are from different UEs, which are schematically depicted as mobile phones 340 and 341. These reports should be distinguished for the BIM to be valid.

The confusion detection may be done based on a combination of different factors, some of which are:
RSRP from cells that are reported with the same PCI e.g. if RSRP levels are very much different, this is schematically depicted in FIG. 3 since the UE 340 and the UE 341 reports RSRP or C/I levels of 6 and 13, respectively. Thus, by using a suitable predetermined threshold value for the difference between the reported PCI values it may be possible to determine a confusion problem.
Other cells that are included in the same measurement report e.g. if the content of two reports with PCI value 2 is very much different (correlation cross-check between reports from UE 340 and UE 341). That is, a suitable indicator for confusion may also be the reported neighbouring cells. In case the reported values for neighbouring cells differ more than a predetermined threshold or even differ at all it may also be an indicator for a confusion problem.

Of course a combination of different factors may be used in order to use it as an indicator that there may be PCI confusion. In case a likely confusion problem is identified a global cell identifier (GCID) might be requested from each of the UEs reporting a cell with target PCI.

Summarizing, exemplary two aspects of the invention may be the following: A first part may relate to the actual detection of measurements coming from different cells however identified with the same PCI value. This might be distinguished based on the content of measurement report (RSRP of a cell/cells with potential PCI confusion, other cells included in the same report with the PCI that may cause confusion). Once the confusion has been identified the serving cell might in a second part ask the reporting UEs to additionally acquire system information blocks (SIBs) of the concerned cells and report the respective cell global identities (CGIs) to the serving cells. This may be similar to the steps performed for inbound mobility procedure as described in R2-100960. Based on this additional information the serving cell receiving such an extended report might be able to distinguish the measurements and update the BIM accordingly. Additionally, the BIM might be additionally extended by a new field which is implemented to store the CGI for cells suffering PCI confusion.

Finally, it should be noted that the above-mentioned embodiments illustrate rather then limit the invention, and that those skilled in the art will be capable of designing many alternative embodiments without departing from the scope of the invention as defined by the appended claims. In the claims, any reference signs shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

### LIST OF REFERENCE SIGNS:

100 Communication network

101 Network cell

102 Network cell

103 Base station

104 Base station

105-112 network elements

220 Measurement report

221 Channel interference

222 Background interference matrix

330-339 Local area nodes

340 User equipment

341 User equipment

1. A network element for a communication network comprising a plurality of network elements, the network element comprising:
an input interface adapted to receive a measurement report associated with a further network element, wherein the measurement report comprises an identifier value identifying the further network element and a first value of a characteristic feature associated with the further network element,
a comparing unit adapted to compare the first value with a second value of the same characteristic feature stored for said identifier value in the network element, and
a signal generating unit adapted to generate a signal in case the comparison of the first value and the second value indicates that the distance between the first value and the second value is above a predetermined threshold.

2. The network element according to claim 1, further comprising:
a sending unit adapted to send the generated signal to another network element.

3. The network element according to claim 2,
wherein the sending unit is further adapted to send a measurement report.

4. The network element according to claim 1, further comprising:
a determining unit adapted to determine a background interference matrix based on received measurement reports.

5. A communication network comprising a plurality of network elements according to claim 1.

6. A method of communication in a communication network by a network element, the method comprising:
receiving a measurement report associated with a further network element, wherein the measurement report comprises an identifier value identifying the further network element and a first value of a characteristic feature associated with the further network element,
comparing the first value with a second value of the same characteristic feature stored for said identifier value in the network element, and
generating a signal in case the comparison of the first value and the second value results indicates that the distance between the first value and the second value is above a predetermined threshold.

7. The method according to claim 6,
wherein the identifier value is the value of the physical cell identity.

8. The method according to claim 6, further comprising:
sending the generated signal.

9. The method according to claim 6,
wherein the generated signal is a request signal.

10. The method according to claim 6, further comprising:
receiving a further identifier value identifying the further network element.

11. The method according to the claim 6
wherein the characteristic feature is a channel interference and/or identifier values of at least one neighbouring network element.

12. The method according to claim 6, further comprising:
determining a background interference matrix based on received measurement reports.

13. The method according to claim 6, further comprising:
receiving or retrieving a further measurement report which comprises the second value.

14. A program element, which, when being executed by a processor, is adapted to control or carry out a method according to claim 6.

15. A computer-readable medium, in which a computer program is stored which, when being executed by a processor, is adapted to control or carry out a method according to claim 6.
